(19) United States
(12) Patent Application Publication
(10) Pub. No.: US 2011/0087825 A1
(43) Pub. Date: Apr. 14, 2011

(54) Electronic Device with Removable USB Flash Drive and USB Flash Drive with Added Functionality

(76) Inventors: Scott W. Cialini, Rochester, NY (US); Miguel Rodriquez, Chili, NY (US)

(21) Appl. No.: 12/576,640

(22) Filed: Oct. 9, 2009

(51) Int. Cl. G06F 12/00; G06F 13/00

(52) U.S. Cl. 711/103; 711/115; 710/302; 711/E12.001; 711/E12.008

(57) ABSTRACT

A USB flash drive for removable connection to another device such as a cell phone, camera, computer, gaming system and photo printer, for example. In one embodiment, a cell phone having a USB port is provided wherein the USB flash drive configured to connect into a slot in the cell phone housing. A user may then quickly transfer data downloaded to the USB flash drive when connected to the cell phone, and another device such as a photo printer, for example. One or more optional additional functionality is incorporated into the USB flash drive such as, for example, a camera, internet card and MP3 player.

### BACKGROUND OF THE INVENTION

The present invention relates to electronic devices, and more particularly relates to hand-held electronic devices such as cell phones and cameras, for example, to which a USB flash drive is removably attachable.

Cell phones and digital cameras are well known and in wide-spread use today. Internet enabled cell phones are known including those having an integral digital camera. Many cell phones have a port allowing them to connect to a laptop to enable the laptop to connect to the internet through the cell phone. To connect the two devices, a cord is provided having a special connector at one end for connection to the port in the cell phone, and a USB connector at the other end for connection to the USB port on the laptop. The specialized connector for attachment to the cell phone is unique to the cell phone manufacturer and will not necessarily adapt to other cell phone manufacturer's devices. The requirement of a separate cord having a specialized connector end presents several drawbacks including, for example, limiting the devices to which the cord will connect, possible loss of the cord, and the inconvenience of having to carry a bulky cord wherever and whenever it is desired to make the connection between the cell phone and a laptop.

USB flash drives are also well know and in wide-spread use. USB flash drives are compact memory storage devices which have a universal connector which may be inserted into a USB port found on almost all new computers today. The storage capacity of USB drives continues to increase and currently may be found in excess of 23 GB of memory although this will increase as technological advancements are made. USB drives may hold almost any type of data and allows for the quick and easy download and transfer of data between different devices having a USB port. Devices that typically include a USB port include personal desk top and laptop computers. There remains a need for an electronic hand held device such as a cell phone or digital camera having a USB port for a removable USB flash drive to allow for quick and easy transfer of data between the cell phone and/or camera and other devices. There is a further need for additional functionality within the USB flash drive to permit such functions as playing music and games, for example.

### SUMMARY OF THE INVENTION

In a first aspect, the present invention comprises a cell phone having a USB port which is adapted to receive the USB connector end of a USB flash drive without the need for a separate cord. In a preferred embodiment, the cell phone housing includes a slot which is configured to receive the housing of the USB flash drive such that the camera housing and USB housing lie substantially flush and form a continuous, non-interrupted surface. As such, the USB flash drive appears as an integral part of the cell phone yet is in fact removable therefrom. In an alternate embodiment, the slot is open only at one end such that the USB flash drive is fully encased within the cell phone housing when connected thereto.

The USB flash drive may further include additional functionality such as an MP3 player capable of downloading and playing digital music through the cell phone or through head phones connected to the cell phone either with a direct wire connection head set or wirelessly (e.g., using Bluetooth technology). The USB drive may further include an internet card capable of establishing an internet connection to the device to which it is attached (e.g., the cell phone or a laptop). The USB flash drive may yet further include a digital camera operable to take and store pictures thereon whether connected to a cell phone or as a stand-alone camera when removed from the cell phone. Of course anything stored on the USB flash drive may then be downloaded to any other device (e.g., a cell phone, a photo printer, a set of stereo speakers, a gaming system, etc.) as desired. Thus, for example, a cell phone having the removable USB flash drive may record a picture which is saved onto the flash drive. The user then removes the USB flash drive from the cell phone and attaches it to a photo printer for printing of the picture. Since the data is stored on the USB flash drive which is removably connected to the cell phone, no separate cord is necessary to transfer the data from the phone/camera to the USB flash drive, or from the USB flash drive to the photo printer.

### BRIEF DESCRIPTION OF THE DRAWING

FIG. 1 is a perspective view of a cell phone according to a first aspect of the invention;

FIG. 2 is a fragmented, elevational view of the back panel of the cell phone of FIG. 1 showing the USB flash drive connected to the cell phone;

FIG. 3 is the view of FIG. 2 showing the USB flash drive removed from the cell phone; and

FIG. 4 is a block diagram showing an embodiment of the USB flash drive and it's selective connection to any one of a variety of different electronic devices.

### DETAILED DESCRIPTION

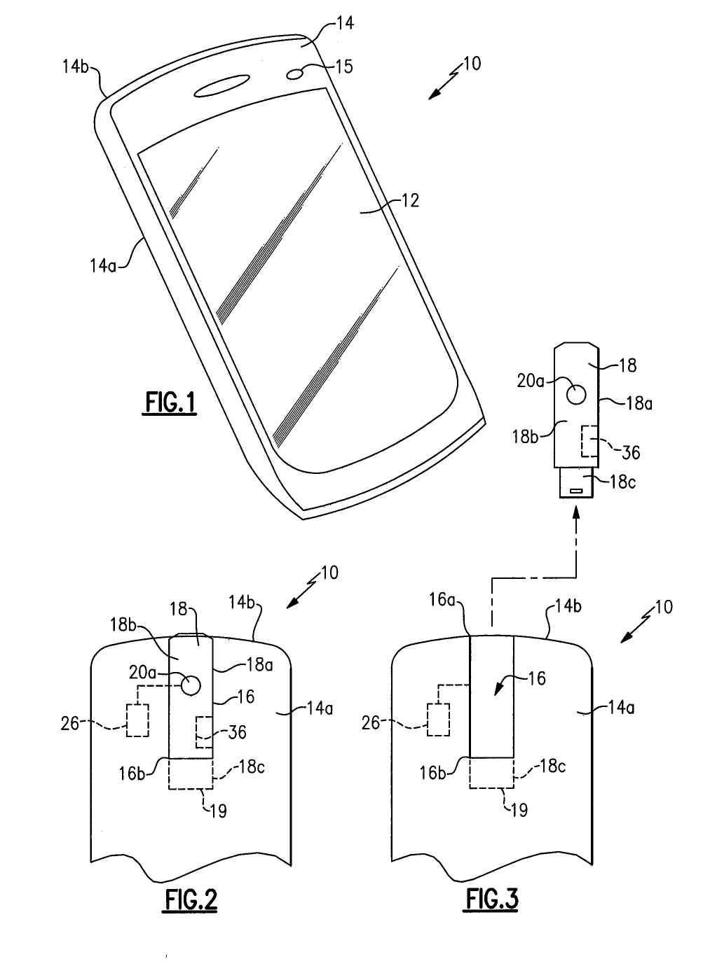

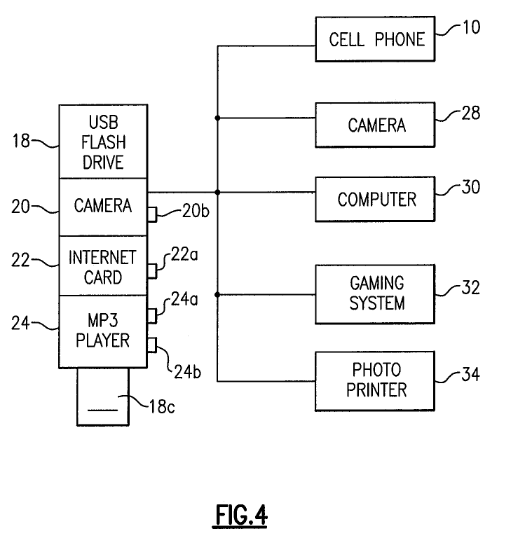

Referring to the drawing, there is seen in FIGS. 1-3 a cell phone designated generally by the reference numeral 10. Although cell phone 10 is shown in a particular configuration, it is understood that a cell phone as used within the context of the present invention may be of any desired configuration and type. In the illustrated embodiment, cell phone 10 includes a graphic user interface (GUI) 12 allowing a user to input commands to the cell phone through a touch screen as found in the iPhone series of cell phones currently offered by Apple. A cell phone housing 14 encases the electronics and GUI 12. FIGS. 2 and 3 show the rear panel 14a of the housing 14 wherein a slot 16 is formed to receive a USB flash drive 18. Slot 16 may be cooperatively configured with USB flash drive housing 18a such that they fit seamlessly together. Slot 16 may be open along cell phone rear housing panel 14a as shown in FIG. 3 such that the USB housing rear panel 18b is exposed and lies flush with cell phone housing rear panel 14a as seen in FIG. 2. Alternatively, slot 16 may be open only at one end 16a, for example, at cell phone housing end wall 14b such that only the end 18c of USB flash drive is exposed when in the attached condition. USB flash drive 18 includes a USB connector 18c which connects to USB port 19 located within housing 14 adjacent slot end 16b. Since USB connector 18c is universal, it can attach to a USB port on any device. Cell phone 10 may optionally include a visual indicator 15 (e.g., an LED) that notifies the user when the USB flash drive is disconnected from cell phone 10. It is intended that cell phone 10 be operational regardless of whether or not USB flash drive 14 is attached thereto.

Besides the usual data storage capacity, one or more various functions may be added to the USB flash drive 18. For example, as seen in FIG. 4, flash drive 18 may further include an optional integral camera 20 having one or more operating buttons 20b, an internet card 22 and/or an MP3 player 24. As seen in FIGS. 2 and 3, USB flash drive 18 may include a camera viewfinder 20a to allow pictures to be taken through viewfinder 20a which are then stored on USB flash drive 18 such that USB flash drive 18 also functions as a stand-alone digital camera. In an alternate embodiment, only the viewfinder 20a is provided on USB flash drive 18 and the camera electronics 26 may be contained within cell phone housing 14 which interface through an appropriate electrical connection when USB flash drive 18 is connected to cell phone 10. In either embodiment, since digital photos may be stored on USB flash drive 18, flash drive 18 may then be removed from cell phone 10 (if previously attached thereto) and attached to another device (e.g., a computer 30 or photo printer 34 as seen in FIG. 4) for downloading the photos to the connected device. It is noted that in one embodiment of the invention, USB flash drive 18 may connect to a separate digital camera 28. In this embodiment, digital camera 20 integral to USB flash drive 18 would not be necessary.

Referring to FIGS. 2-4, USB flash drive 18 may optionally include a wireless internet card 36 which functions to establish an internet connection with the device to which USB flash drive 18 is attached. Internet cards are known and in wide spread use to establish an internet connection (typically via a cellular network) with a laptop computer to which the card is attached. When USB flash drive 18 is connected to a computer 30, integral internet card 36 functions to establish an internet connection such that no separate internet card, cable or modem is necessary. One or more buttons 22a may be provided to control operation of internet card 22 as desired.

USB flash drive 18 may further optionally include an integral MP3 player 24 which functions like a conventional MP3 player. Appropriate buttons 24a and 24b may be provided on USB flash drive 18 to operate the MP3 player in either the unattached or attached condition of USB flash drive 18 to another device. MP3 player 24 may operate either through a conventional head set connection or a wireless technology such as Bluetooth.

Referring again to FIG. 4, USB flash drive may be connected to any device having a USB port such as, for example, cell phone 10, camera 28, computer 30, gaming system 32 or photo printer 34. In gaming systems such as Play Station and XBox, game cartridges are used to play and store games such that the level of play attained may be stored and accessed for future play. In an embodiment of the invention, USB flash drive 18 includes the electronics necessary to store the game in the same manner as a game cartridge. The USB flash drive 18 may then be reconnected to the user's cell phone 18. In one embodiment, the game may be played on the cell phone in a game version that is scaled to the RAM/ROM capacity of the particular cell phone, understanding that the RAM/ROM capability of a stand-alone gaming system such as Play Station and XBox consoles is much higher than in a hand-held device although this may change as the technology advances. Regardless of whether the cell phone is capable of playing a game from the USB flash drive, the present invention provides the easy portability of the stored game with the attachment of the USB flash drive 18 to the user's cell phone 10. As such, the user may travel to another location, detach the USB flash drive 18 from his/her cell phone 10 and connect it to another gaming system 32.

USB flash drive 14 may include a separate power source as required for the particular embodiment (e.g., lithium battery—not shown).

It will thus be appreciated that the present invention provides an advancement over the state of the art in electronic devices by providing in a first aspect thereof a cell phone having a removable USB flash drive. In another embodiment, the invention provides a digital camera having a removable USB flash drive. In yet another embodiment, the USB flash drive may include additional functionality such as an integral digital camera and/or viewfinder, an internet card and/or an MP3 player which may then be used with another device to which the USB flash drive may connect through a USB port. As such, no separate cords are necessary as the UBS flash drive may connect to any device having a USB port. In a particularly useful embodiment, a cell phone having a USB port is provided to which the USB flash drive may be removably connected. This permits the user great freedom in having the two devices together which reduces the chance of misplacing one relative to the other. Further embodiments depending on the desired functionality are of course possible and within the scope of the invention.

What is claimed is:

1. An electronic device, comprising:
a. a cell phone having a USB port; and
b. a USB flash drive removably attached to said USB port of said cell phone.

2. The device of claim 1, wherein said cell phone includes a housing having a slot formed in a wall portion thereof, said slot configured to removably receive said USB flash drive, said USB flash drive having a housing with a wall portion thereof configured to lie flush with said wall portion of said cell phone housing.

3. The device of claim 2 wherein said flash drive further includes a digital camera operable to take pictures either when attached to said cell phone or removed therefrom.

4. The device of claim 3 wherein said USB flash drive further includes an integral internet card.

5. The device of claim 4 wherein said USB flash drive is operable to store an electronic game and interface with a gaming device when said USB flash drive is separated from said cell phone.

6. The device of claim 4 wherein said USB flash drive is operable to store and play an electronic game on said cell phone when attached thereto.

7. An electronic device, comprising:
a. a digital camera having a USB port; and
b. a USB flash drive removably attached to said USB port of said digital camera.

8. A USB flash drive including an integral digital camera.

9. A USB flash drive including an integral internet card.

10. A USB flash drive including an integral MP3 player.

11. A USB flash drive including an integral digital camera, an integral internet card, and an integral MP3 player.

12. The USB flash drive of claim 11 wherein one or more buttons are provided on said USB flash drive for operating one or more of said digital camera, said internet card, and said MP3 player.
